(19) United States
(12) Patent Application Publication
(10) Pub. No.: US 2026/0110370 A1
(43) Pub. Date: Apr. 23, 2026

(54) SYSTEMS AND METHODS FOR AUTONOMOUS PRESSURE RELIEF VALVE TESTING

(71) Applicant: Emerson Automation Solutions Final Control US LP, Houston, TX (US)

(72) Inventors: Marcelo Dultra, Stafford, TX (US); William Bockeloh, Stafford, TX (US)

(21) Appl. No.: 19/374,391

(22) Filed: Oct. 30, 2025

Related U.S. Application Data
(62) Division of application No. 18/192,547, now abandoned.
(60) Provisional application No. 63/085,912, filed on Sep. 30, 2020.
(60) Provisional application No. 63/155,166, filed on Mar. 1, 2021.

(51) Int. Cl. F16K 37/00; F15B 13/02; F15B 19/00; F16K 17/04; F16K 31/40

(52) U.S. Cl. CPC F16K 37/0083; F15B 13/024; F15B 19/00; F16K 17/0413; F16K 31/406; F15B 2211/50518; F15B 2211/855

(57) ABSTRACT

A control system for a pressure relief valve can include a controller and an actuator. The controller can control the actuator to at least partially open a main valve of the pressure relief valve and can determine one or more operational characteristics of the pressure relief valve based on a response of the valve to the controlled movement of the actuator.

### CROSS-REFERENCE TO RELATED APPLICATIONS

This application is a divisional of U.S. patent application Ser. No. 18/192,547, filed on Mar. 29, 2023, which represents the national stage entry of PCT/US2021/052888, filed on Sep. 30, 2021, which claims priority to U.S. Provisional Ser. No. 63/085,912, filed on Sep. 30, 2020, and U.S. Provisional Ser. No. 63/155,166, filed on Mar. 1, 2021, the entireties of which are incorporated herein by reference.

### BACKGROUND

Relief valves, such as spring-operated pressure relief valves and pilot-operated pressure relief valves, are often used in systems and vessels where pressure protection is required. For example, in such systems, excess pressure can lead to a process upset, instrument failure, or equipment failure. Pressure relief valves allow excess pressure to be relieved by allowing pressurized fluid flow from an auxiliary passage out of the system. Throughout the life of a relief valve, it can be useful to monitor operation information of the valve, which can enable proactive corrective action, maintenance schedule optimization, and asset management improvement.

### SUMMARY

Some embodiments provide a control system for a spring-operated pressure relief valve with a disc assembly configured to seal against a valve seat, a main spring configured to bias the disc assembly toward the valve seat, and a spindle connected to the disc assembly to guide movement of the disc assembly relative to the valve seat. The control system can include a controller and an actuator. The actuator can be configured to be connected to the spindle. The controller can be configured to, when the actuator is connected to the spindle, control the actuator to move the disc assembly via the spindle, to at least partially open the valve for flow across the valve seat, and determine one or more operational characteristics of the spring-operated pressure relief valve based on a response of the valve to the controlled movement of the disc assembly.

In some embodiments, a controller (or logic solver) can be generally implemented as a processing device that is configured to execute a set of instructions, to receive inputs (e.g., user test commands and inputs representative of process conditions), and manipulate outputs (e.g., outputs to the actuator) to conduct the various autonomous tests described herein and to provide the results thereof. The controller may be configured as a standalone controller (e.g., a field-mounted controller that is configured to execute customized instructions associated with the autonomous tests) or as a central process control system, such as a distributed control system (DCS) or safety instrumented system (SIS). In the case of a standalone controller, the controller may be linked to a central control system (e.g., via a wired or wireless connection) to enable efficient initiation of the various tests from the central control system (e.g., via manual or scheduled test initiation).

In some embodiments, a control system can include a controller and an actuator. The actuator can be a pressure-operated actuator and the controller can be configured to controllably direct a pressurized flow to the actuator to control the actuator to move a disc assembly.

In some embodiments, a control system can include one or more control valves configured to regulate pressurized flow to an actuator based on signals from a controller. A pressure sensor can be in communication with an inlet of a spring-operated pressure relief valve.

In some embodiments, a control system can include a controller. The controller can be configured to conduct a partial-stroke test for a spring-operated pressure relief valve, via control of one or more control valves.

In some embodiments, a control system can include a two-way pressure-operated actuator. A controller can be configured to, via control of one or more control valves, conduct a partial-stroke test for a spring-operated pressure relief valve.

In some embodiments, a control system can include a two-way pressure-operated actuator. A controller can be configured to, via control of one or more control valves, conduct operational diagnostics of a spring-operated pressure relief valve.

In some embodiments, a control system can include a two-way pressure-operated actuator. A controller can be configured to, via control of one or more control valves, provide supplemental loading on a disc assembly via a spindle, in parallel with a main spring.

In some embodiments, a control system can include a positioner. The positioner can be configured to control a pressure of a pressurized flow at an actuator and determine position measurements for the control system during movement of a disc assembly. A controller can be configured to, via control of the positioner, one or more of: conduct a partial-stroke test for a spring-operated pressure relief valve, or conduct operational diagnostics of the spring-operated pressure relief valve.

In some embodiments, a control system can include a two-way pressure-operated actuator. A controller can be configured to, via control of a positioner, one or more of: conduct a partial-stroke test for a spring-operated pressure relief valve, conduct an operational diagnostics of the spring-operated pressure relief valve, or provide supplemental loading on a disc assembly via a spindle, in parallel with a main spring.

In some embodiments, a control system can include an electric actuator and a controller. The controller can be configured to electronically control the electric actuator to move a disc assembly.

In some embodiments, a control system can include a controller configured to, via electric control of an actuator, one or more of: conduct a partial-stroke test for a spring-operated pressure relief valve, conduct operational diagnostics of the spring-operated pressure relief valve, or provide supplemental loading on a disc assembly via a spindle, in parallel with a main spring.

Some embodiments provide a method of operating a control system for a spring-operated pressure relief valve. The method can include conducting operational diagnostics of the spring-operated pressure relief valve by: with a controller, controlling an actuator to open the valve to a specified lift, determining a first time required to open the valve to the specified lift, and subsequently, with the controller, controlling the actuator to re-open the valve to the specified lift, determining a second time required to re-open the valve to the specified lift, and comparing the first and second times to identify an operational state for the spring-operated pressure relief valve.

In some embodiments, a method of operating a control system for a spring-operated pressure relief valve can include conducting operational diagnostics of the spring-operated pressure relief valve by controlling an actuator to open the valve to a specified lift. The specified lift can be a partial lift.

Some embodiments provide a method of operating a control system for a spring-operated pressure relief valve. The method can include conducting operational diagnostics of the spring-operated pressure relief valve by: with a controller, controlling an actuator to open the valve, determining a force applied by an actuator or a force input at the actuator corresponding to opening the valve, and determining a set pressure of the valve based on the force applied by the actuator or the force input at the actuator.

In some embodiments, a method of operating a control system for a spring-operated pressure relief valve can include controlling an actuator to open the valve. An open state of the valve can be determined based on a sensor located downstream of a valve seat.

Some embodiments provide a control system for a pilot-operated pressure relief valve with a main valve having a main valve seat, a main piston configured to seal against the main valve seat, and a dome, and a pilot valve that includes a pilot spring that biases a pilot piston toward a pilot seat to control flow through the pilot valve, the pilot valve being in communication with an inlet of the main valve and the dome to control pressure within the dome. The control system can include a pressure sensor arranged to measure a pressure difference between an inlet to the pilot valve and the dome, a controller, and a vent. The vent can be in communication with the dome and a pressure source. The controller can be configured to control the vent valve to at least partially vent the dome, to cause the main piston to at least partially open the main valve for flow across the main valve seat and identify that the main valve is at least partially open as a result of the control of the vent valve, based on one or more signals from the pressure sensor.

In some embodiments, a control system can include a sensor downstream of a main valve seat. A controller can be configured to, when a main valve is at least partially opened by the control of a vent valve, identify a set pressure of a pilot-operated pressure relief valve based on one or more signals from the sensor downstream of the main valve seat.

In some embodiments, a control system can include an acoustic transmitter.

Some embodiments provide a method of operating a control system. The method can include determining a set pressure of a pilot operated relief valve by, with a controller, controlling a vent valve to partially vent a dome. Upon partially venting the dome, the method can include identifying an initial lift of a main piston from a valve seat based on one or more signals from a sensor downstream of a main valve seat. The method can include determining the set pressure based on a pressure differential signal from a pressure sensor that corresponds to the identified initial lift of the main piston.

Some embodiments provide a control system for a pilot-operated pressure relief valve with a main valve having a main valve seat, a piston configured to seal against the main valve seat, and a dome, and a pilot valve that includes a pilot spring that biases a pilot piston toward a pilot seat to control flow through the pilot valve, the pilot valve being in communication with an inlet of the main valve and the dome to control pressure within the dome. The control system can include a pressure sensor arranged to measure a pressure difference between an inlet to the pilot valve and the dome, a controller, and an actuator. The actuator can be configured to be connected to the pilot piston. The controller can be configured to, when the actuator is connected to the pilot piston, control the actuator to move the pilot piston, to at least partially open the pilot valve to vent the dome, and determine one or more operational characteristics of the spring-operated pressure relief valve based on a response of the valve to the controlled movement of the pilot piston.

In some embodiments, a controller can include a pressure-operated actuator and a controller. The controller can be configured to controllably direct a pressurized flow to the actuator to control the actuator to move a pilot piston.

In some embodiments, a control system can include one or more valves configured to regulate a pressurized flow to an actuator based on signals from a controller.

In some embodiments, a control system can include a positioner configured to control a pressure of a pressurized flow at an actuator and determine position measurements for the control system during movement of a disc assembly.

In some embodiments, a control system can include an electric actuator and a controller. The controller can be configured to electronically control the actuator to move a pilot piston.

In some embodiments, a control system can include a controller, one or more valves, a positioner, and an electric actuator. The controller can be configured to, via one of the one or more valves, the positioner, or the electric actuator, conduct a partial-stroke test for a pilot-operated pressure relief valve and/or conduct operational diagnostics of the pilot-operated pressure relief valve.

In some embodiments, a control system can include a controller configured to determine a set pressure of a pilot-operated pressure relief valve based on control of an actuator and pressure data from a pressure sensor.

Some embodiments provide a method of operating a control system. The method can include conducting operational diagnostics of a pilot-operated pressure relief valve by: with a controller, controlling an actuator to move a pilot piston, to cause a main piston to move, to open a main valve a specified lift, determining a first time required to open the main valve to the specified lift, and subsequently, with the controller, controlling the actuator to re-open the main valve to the specified lift. The method can also include determining a second time required to re-open the main valve to the specified lift, and comparing the first and second times to identify an operational state for the pilot-operated pressure relief valve.

In some embodiments, a method for operating a control includes opening a main valve a specified lift. The specified lift can be a partial lift.

Some embodiments provide a method of operating a control system. The method can include conducting operational diagnostics of a pilot-operated pressure relief valve by: with a controller, controlling an actuator to open a main valve, determining a force applied by the actuator or a force input at the actuator corresponding to opening the main valve, and determining a set pressure of the valve based on a force applied by the actuator or the force input at the actuator.

In some embodiments, a method of operating a control system can include determining an open state of a valve based on one or more of a sensor located downstream of a main valve seat or a pressure sensor.

Some embodiments provide a control system for a pressure relieve valve with a valve member (e.g., a disc assembly or a pilot piston) configured to seal against a valve seat, and a spring that biases the valve member toward the valve seat. The control system can include a controller and an actuator configured to be connected to the valve member. The controller can be configured to, when the actuator is connected to the valve member: control the actuator to move the valve member, to at least partially open the valve; and determine one or more operational characteristics of the pressure relief valve based on a response of the valve to the controlled movement of the valve member.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a schematic illustration of a spring-operated pressure relief valve control system including a control valve and a one-way actuator, according to an embodiment of the invention.

FIG. 2 is a schematic illustration of a spring-operated pressure relief valve control system including a positioner and a one-way actuator, according to an embodiment of the invention.

FIG. 3 is a schematic illustration of a spring-operated pressure relief valve control system including an electric actuator, according to an embodiment of the invention.

FIG. 4 is a schematic illustration of a spring-operated pressure relief valve control system including control valves and a two-way actuator, according to an embodiment of the invention.

FIG. 5 is a schematic illustration of a spring-operated pressure relief valve control system including a positioner and a two-way actuator, according to an embodiment of the invention.

FIG. 6 is a schematic illustration of a pressure relief valve control system configured for set pressure validation, according to an embodiment of the invention.

FIG. 7 is a schematic illustration of a pilot-operated pressure relief valve control system including a pressure sensor and a vent valve in communication with a dome of the relief valve and a pressure source, according to an embodiment of the invention.

FIG. 8 is a schematic illustration of a pilot-operated pressure relief valve control system including a pressure sensor and a control valve, according to an embodiment of the invention.

FIG. 9 is a schematic illustration of a pilot-operated pressure relief valve control system including a pressure sensor and a positioner, according to an embodiment of the invention.

FIG. 10 is a schematic illustration of a pilot-operated pressure relief valve control system including a pressure sensor and an electric actuator, according to an embodiment of the invention.

### DETAILED DESCRIPTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like (e.g., the same, similar, or resembling) elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the attached drawings. The invention is capable of other embodiments and of being practiced or of being carried out in various ways. Also, it is to be understood that the phraseology and terminology used herein is for the purpose of description and should not be regarded as limiting. For example, the use of “including,” “comprising,” or “having” and variations thereof herein is meant to encompass the items listed thereafter and equivalents thereof as well as additional items.

As used herein, unless otherwise specified or limited, the terms “mounted,” “connected,” “supported,” “secured,” and “coupled” and variations thereof, as used with reference to physical connections, are used broadly and encompass both direct and indirect mountings, connections, supports, and couplings. Further, unless otherwise specified or limited, “connected,” “attached,” or “coupled” are not restricted to physical or mechanical connections, attachments or couplings.

As briefly discussed above, certain systems and vessels require pressure protection to avoid over-pressurization. Spring-operated pressure relief valves and pilot-operated pressure relief valves can be used in such systems to relieve and divert excess fluid pressure. Because pressure relief valves can be an integral component of certain systems, it can be useful to monitor operation characteristics of such valves to help ensure expected performance of the valves over time or identify potential need for valve maintenance or replacement. One method of monitoring the operation of pressure relief valve and generally reducing the need for scheduled testing is continuous monitoring. In general, continuous monitoring can provide real-time information which can enable proactive correction action, maintenance schedule optimization, and asset management improvement, while helping to promote regulatory compliance within the system.

Some embodiments of the invention provide a monitoring and control system for continuous or discrete monitoring of valves, including via remote controls, as can be used to detect and time stamp relief events as well as leakages, set pressure validation, and volumetric releases, among other valve states or events. In general, correlating real-time pressure relief valve monitoring information with process data and maintenance records can help enable accurate root cause failure analyses or other diagnostic efforts. Data analytics and remote connection can also allow real-time troubleshooting and can help ensure system operating quality. Additionally, pressure relief valves may be installed in complicated industrial or hazardous areas, and remote monitoring can reduce the need for visual inspections, thereby limiting the amounting of time an operator spends in such area.

Throughout the life of a relief valve, it can be useful to monitor status and operation information of the valve, which can enable proactive corrective action, maintenance schedule optimization, and asset management improvement. In this regard, for example, in addition to monitoring a status of a pressure relief valve, some embodiments of the invention provide a method of autonomous testing of pressure relief valves. For example, such testing capabilities can include a partial stroke test, a set pressure test, and other diagnostics. In general, a partial stroke test can be utilized to verify valve function (e.g., confirm that a valve will open during a relief event). A set pressure test can be used to verify that a valve assembly will actuate the main valve of a pressure relief valve at the expected pressure to protect a system. And other diagnostics can provide a variety of other information to assist in evaluating operational status and potential issues for a valve.

In some embodiments, diagnostics that are facilitated by the disclosed control systems can include measuring valve variables that are indicative of wear and tear, or reduced performance, such as friction or stiction within the valve. In some cases, such operational diagnostics can help determine the health or actual or expected life span of the valve. For example, during an operational diagnostic test of a pressure relief valve, a controller can control an actuator to lift a valve to a specified lift and determine a first time and/or a first amount of force that was required to open the valve to the specified lift. Later in the operational lifespan of the valve, the controller can again control the actuator to re-open the valve to the specified lift and a second time and/or a second amount of force required to re-open the valve can be determined. The first and second times and/or forces can then be compared to identify an operational state of the valve. For example, if the second time or force is significantly longer or higher than the first time or force, after weeks, months, years, etc. of valve operation, it may be determined that certain valve wear may have occurred and appropriate maintenance or replacement may be required.

In some configurations, spring-operated pressure relief valves can be used to relieve and divert excess fluid pressure. In general, spring-operated pressure relief valves include a spring that is compressed by a predetermined value. The spring provides a force on a valve disc in a valve-closing direction (e.g., downward), thereby biasing the valve toward a closed position. When an opening force (e.g., upward) exerted by a pressurized fluid acting on the valve disc equals the closing force (e.g., downward) of the spring, plus any ancillary forces (e.g., due to the weight of the disc assembly), the valve begins to open. As the fluid pressure continues to increase, the spring is further compressed, and the valve is further opened.

Spring-operated pressure relief valves are generally configured to provide a set pressure, which is typically predetermined and preset before installation of the valve by adjustment of a main spring of the valve. The set pressure is typically a pressure at which the valve opens and there is a significant relief of the system pressure, although other definitions are applied in different installations, as is known in the industry. Further, in general, valve lift can be defined as a distance between seating surfaces of a disc assembly and a nozzle in a spring-operated pressure relief valve, as the valve transitions between a closed and open position. The lift is said to be zero when the valve is in the closed position, and the lift reaches a maximum when the valve is in a fully opened position.

Embodiments of the invention can provide a control system for a spring-operated pressure relief valve. As briefly described above, the spring-operated pressure relief valve can include a disc assembly that is configured to seal against a valve seat, a main spring that is configured to bias the disc assembly toward the valve seat, and a spindle connected to the disc assembly to guide movement of the disc assembly relative to the valve seat. The control system can include a controller and an actuator that can be connected to the spindle. The controller can control the actuator to move the disc assembly, via the spindle, to at least partially open the valve for flow across the valve seat. Further, the control system can be configured to determine operational characteristics of the spring-operated pressure relief valve based on a response of the valve to the controlled movement of the disc assembly. Such operational characteristics can include, for example, diagnostic data, as generally described above, confirmation of a partial stroke test, and a set pressure (e.g., an amount of force (and related fluid pressure) required to overcome the spring force and open the relief valve).

As briefly described above, a partial stroke test can be used to verify valve functionality. With regard to the spring-operated pressure relief valve, the control system can include an actuator generally configured to lift the disc assembly from the valve seat. During the partial stroke test, the actuator lifts the disc assembly from the valve seat to open the valve partially (e.g., to a predetermined partial valve lift) to verify that the valve can indeed open during an operational relief event.

Further, with regard to the spring-operated pressure relief valve, some embodiments can be configured to determine a set pressure of the valve based on a force applied by the actuator (or other force input or measurement). In some embodiments, the controller of the control system can be configured to control one or more control valves to provide supplemental loading on the disc assembly via the spindle, in parallel with the main spring.

In general, supplemental loading can provide a closing force on a disc assembly of a valve to ensure full contact between the disc assembly and the valve seat, and can thereby reduce valve chatter (i.e., small and rapid lift events of the disc assembly from the valve seat) during certain operations, such as during a startup operation, for example. Generally, a supplemental loading force is only applied to the disc assembly when the valve is in the closed position and is removed during relief events. For example, the controller that controls the actuator that applies the supplemental loading can also receive input that indicates the inlet pressure at the relief valve so that the controller can instruct the actuator to cease supplying the supplemental loading when the valve is expected or required to vent. Thus, for example, the disc assembly can lift normally off of the valve seat when the set pressure at the inlet is reached.

A control system for a relief valve can include a variety of components that can be used individually or in combination to provide certain autonomous control functionality or determine various operational characteristics of the spring-operated pressure relief valve. For example, a controller can include a hardware device or a software system, such as a logic solver, in communication with a control valve, such as a solenoid-operated or pilot-operated valve, for example. As another example, a controller can be in communication with a pressure sensor that is in communication with an inlet of the spring-operated pressure relief valve. Such a pressure sensor can include a pressure switch or a pressure transmitter, for example, which can relay pressure information to a controller for control of a control valve (e.g., via a solenoid) based on the inlet pressure (or a related pressure differential). In some embodiments, a controller of a control system for a spring-operated pressure relief valve can be in communication with a positioner that is configured to directly control an actuator and move the actuator to a specified position or with a specified driving pressure.

A control system for a relief valve can also generally include an actuator. An actuator can include, for example, a pneumatic actuator, a hydraulic actuator, or an electric actuator (e.g., a motor). In particular, each of the hydraulic or pneumatic actuators can be configured as one-way or two-way actuators, in different embodiments. In general, the actuator can be controlled via the controller in order to apply force to a disc assembly of a relief valve in one or more directions (e.g., selectively in the opening direction, the closing direction, or both). In the example of an actuator configured as a motor, the actuator may be controlled by electric actuation, rather than hydraulic or pneumatic actuation in the case of hydraulic and pneumatic actuators. In some cases, a two-way actuator, including some motor actuators, can provide supplementary loading to a spring-operated pressure relief valve by providing an actuating force in a first direction to open the valve and an actuating force in a second, opposing direction to close the valve.

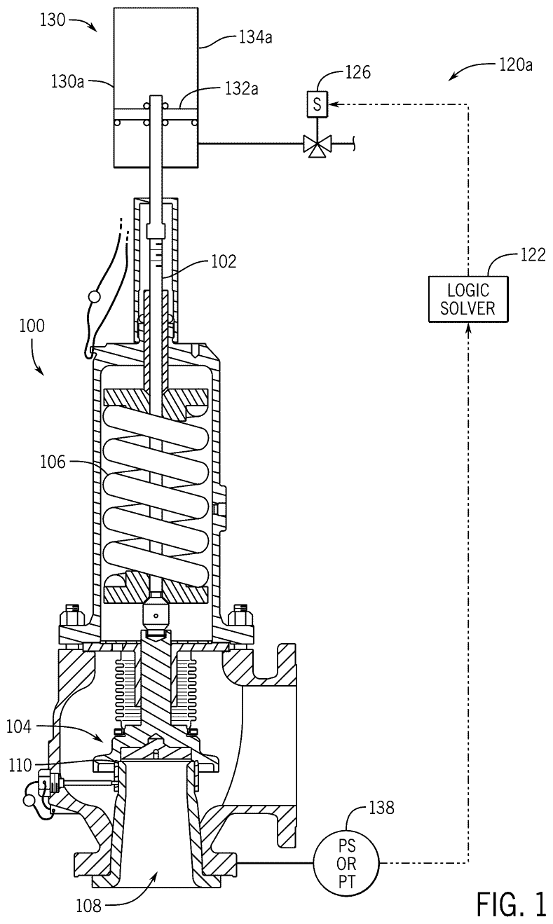

The following description of FIGS. 1-5 below provide various example embodiments of a control system 120a-e for a spring-operated pressure relief valve 100. The pressure relief valve 100 illustrated in FIGS. 1-5 includes a back pressure balance relief system (i.e., a bellows), however, other pressure relief valves can be used with the control systems 120a-e described below. Each embodiment described below can provide remote actuation and monitoring for a spring-operated pressure relief valve 100 via a controller 122 and an actuator 130, with the actuator 130 connected to (and configured to move) a valve member, configured as a spindle 102 and disc assembly 104 of the valve 100, and the controller 122 configured to control the actuator 130. Further, each embodiment described below can allow certain operation characteristics to be determined, including as outlined above. In general, like reference numbers for the same or similar components, where applicable, will be used across the various example embodiments below in varying configurations.

With reference to FIG. 1, a controller 122 (e.g., a logic solver, as shown) of a control system 120a is in communication with a solenoid valve 126, and an actuator 130 is configured as a piston-cylinder assembly 130a that is attached to a spindle 102 of the relief valve 100 and in fluid communication with the solenoid valve 126. In the illustrated embodiment, the actuator 130 (i.e., the piston-cylinder assembly 130a) is a one-way actuator and is pressure-operated (e.g., via hydraulic or pneumatic pressure). Thus, in general, the solenoid valve 126 can control flow of pressurized fluid (e.g., air or hydraulic fluid) to actively move a piston 132a within a cylinder 134a of the piston-cylinder assembly 130a in a single direction to at least partially open the valve 100. In other words, the controller 122 (via the solenoid valve 126) can controllably direct a pressurized fluid to the actuator 130 to move a disc assembly 104 of the relief valve 100. For example, the solenoid valve 126 can be energized (e.g., via a signal from a logic solver) to pressurize the piston-cylinder assembly 130a and thereby open the valve 100, and the solenoid valve 126 can be de-energized to vent the piston-cylinder assembly 130a and thereby allow a main spring 106 to close the valve 100.

In some implementations, the control system 120a of FIG. 1 can also include a pressure sensor 138. For example, a pressure sensor can be configured as a pressure switch, a pressure transmitter, or another pressure sensor, in communication with an inlet 108 of the spring-operated pressure relief valve 100, so that a signal representing pressure at the relief valve inlet 108 can be provided to the controller 122.

In some embodiments similar effects can also be achieved with other arrangements. For example, types of control valves other than the illustrated solenoid valve 126 can be used to similar effect in some cases (for the embodiment of FIG. 1 and other embodiments disclosed herein). Similarly, as generally noted above, a variety of controllers of known types, including mechanical, fluid, electronic, or combination controllers, can be used in different embodiments.

In use, a partial stroke test may be conducted using the control system 120a of FIG. 1 by signaling to the controller 122 to actuate the piston-cylinder assembly 130a (e.g., by opening the solenoid valve 126), to lift the disc assembly 104 from the valve seat 110. The pressure sensor 138 can then relay a sensed pressure at the valve inlet 108 to the controller 122 to indicate whether a relief event has or has not occurred as a result of the commanded opening of the relief valve 100, to verify whether the relief valve 100 can be expected to also open during system operation (e.g., when a set pressure is reached). Once the partial stroke test is complete, the solenoid valve 126 can be de-energized to allow the piston-cylinder assembly 130a to vent, and the disc assembly 104 can thereby return to an operating position that is no longer influenced by the actuator 130.

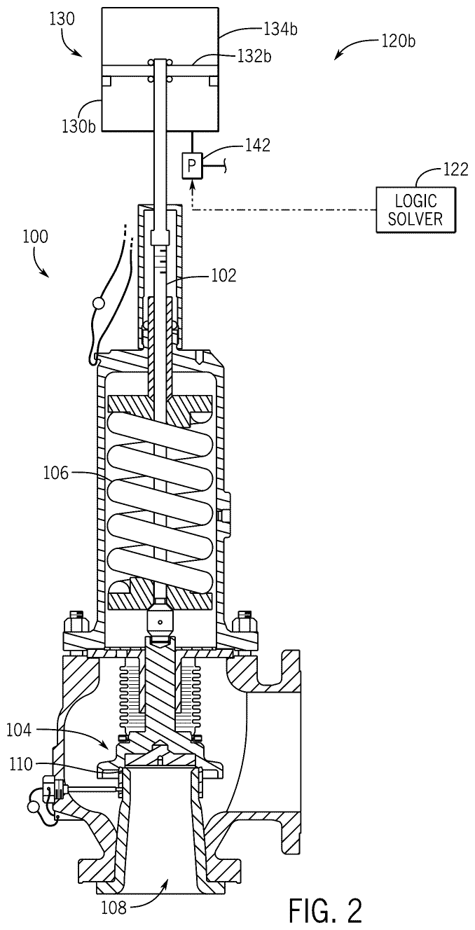

In some implementations, including for the embodiment of FIG. 1 and other embodiments discussed below, verification of valve lift can be achieved in other ways. For example, a limit switch or other position sensor can be configured to indicate when the spindle has traveled a particular distance (e.g., to indicate 20% valve lift, 50% valve lift, etc.) FIG. 2 illustrates another example embodiment of a control system 120b. In the illustrated embodiment, the control system 120b includes a controller 122 (e.g., a logic solver) in communication with a positioner 142, and an actuator 130 configured as a piston-cylinder assembly 130b that is attached to the spindle 102 of the relief valve 100. As is understood in the art, a positioner is generally configured to control a pressurized flow of fluid (e.g., to selectively regulate outlet pressure) and to measure displacement of a component. Correspondingly, some embodiments discussed herein as using positioners can be alternately configured with a combination of separate known components that can operate with a similar collective effect.

In the illustrated embodiment, the actuator 130 is a one-way actuator and is pressure-operated. Thus, in general, the positioner 142 can control the piston 132b in a single direction to at least partially open the valve 100. In particular, for the illustrated configuration, the positioner 142 can be used to controllably move the piston 132b within the piston-cylinder assembly 130b by increasing or decreasing pressure within the cylinder 134b. An increase in pressure controlled by the positioner 142 corresponds to moving the piston 132b to actuate the valve 100 and move the disc assembly 104 into at least a partially open position.

In use, a partial stroke test may be conducted by signaling to the positioner 142 to actuate the piston-cylinder assembly 130b (i.e., pressurize the piston-cylinder assembly) to lift the disc assembly 104 from the valve seat 110. The positioner 142 can then relay a sensed position of the piston 132b within the piston-cylinder assembly 130b or of the spindle 102 of the relief valve 100, which corresponds to a lift height of the disc assembly 104, to thereby verify that the valve 100 will open during a relief event and determine the pressure required to open the valve 100 (i.e., the set pressure). The control system 120b illustrated in FIG. 2 can also conduct operational diagnostics, as described above, including by recording a time it takes to reach a specified lift height via the positioner 142 and the controller 122 at different times during the lifespan of the relief valve 100.

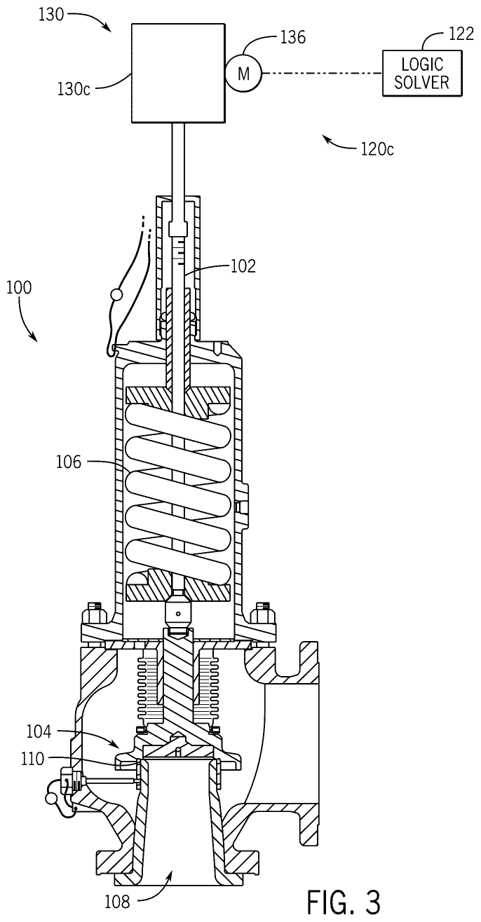

FIG. 3 illustrates another example embodiment of a control system 120c. In the illustrated embodiment, the control system 120c includes an actuator 130 configured as an electric actuator 130c including a motor 136, configured to be controlled by a controller 122 (e.g., a logic solver). The electric actuator 130c is coupled with the spindle 102 of the relief valve 100, so that the motor 136 can control the electric actuator 130c to move the spindle 102 to open and close the valve 100. In general, the motor 136 can provide two-way actuation.

In use, a partial stroke test may be conducted by signaling to the motor 136 to actuate the actuator 130 to lift the disc assembly 104 from the valve seat 110. Rotation of the motor 136 can be monitored (e.g., counted) or displacement of the spindle 102 due to rotation of the motor 136 otherwise sensed (e.g., with a limit switch), and the controller 122 can thereby verify that the relief valve 100 will open during a relief event. In some cases, a force applied to open the relief valve 100 can also be determined (e.g., by sensing current through the motor 136) and the pressure required to open the valve 100 (i.e., the set pressure) can thereby also be determined. The control system 120c illustrated in FIG. 3 can also conduct operational diagnostics, as described above. Further, the control system 120c illustrated in FIG. 3 can provide supplementary loading to the valve 100 by actuating the electric actuator 130c in a direction that corresponds to the disc assembly 104 being urged toward the valve seat 110.

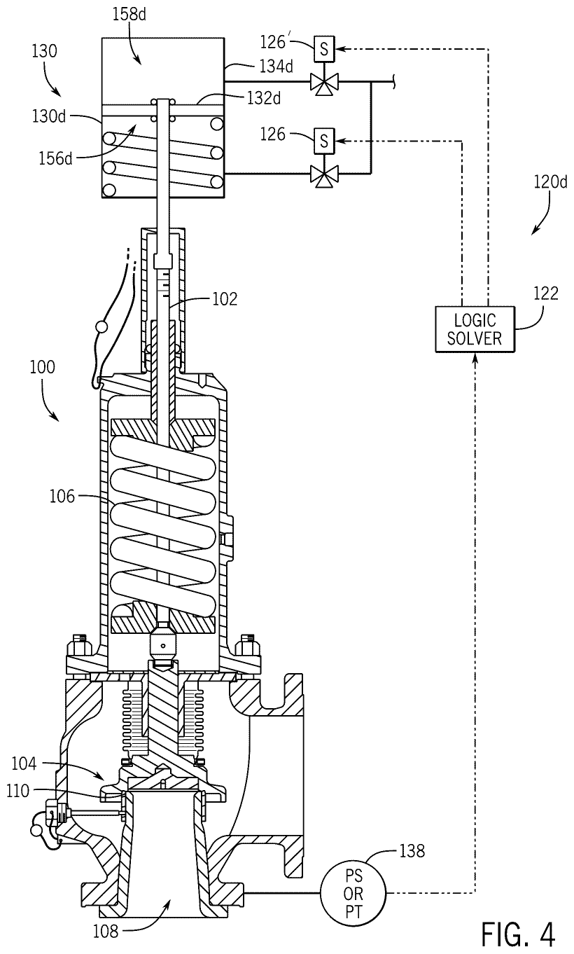

FIG. 4 illustrates another example embodiment of a control system 120d. In the illustrated embodiment, the control system 120d includes a controller 122 (e.g., a logic solver) in communication with a first solenoid valve 126 and a second solenoid valve 126′, and an actuator 130 configured as a piston-cylinder assembly 130d which is attached to the spindle 102 of the relief valve 100. In the illustrated embodiment, the actuator 130 is a two-way actuator and is pressure-operated. Correspondingly, in general, the solenoid valves 126, 126′ can be controlled to selectively cause the piston 132d to move in either two directions to at least partially open the relief valve 100 and to close the relief valve 100. To open the valve 100 at least partially, the first solenoid 126 can be energized to pressurize a first side 156d of the piston 132d within the cylinder 134d and the second solenoid 126′ can be de-energized to depressurize a second side 158d of the piston 132d within the cylinder 134d. In a similar way, to close the valve 100, the first solenoid 126 can be de-energized to depressurize the first side 156d of the piston 132d and the second solenoid 126′ can be energized to pressurize the second side 158d of the piston 132d.

As also generally discussed above, pressurization of the second side 158d of the piston 132d to close the valve 100 corresponds to supplemental loading of the valve 100, with corresponding benefits as generally discussed above. As also described above, however, supplemental loading may require pressure inputs to the controller 122 (e.g., the logic solver) to ensure that the second solenoid 126′ is de-energized when the pressure at the valve inlet 108 reaches the set pressure.

In the illustrated embodiment, the control system 120d can also include a pressure sensor 138. The pressure sensor 138 can be configured as a pressure switch, a pressure transmitter, or another pressure sensor. In use, a partial stroke test may be conducted by signaling to the controller 122 to actuate the piston-cylinder assembly 130d′ to lift the disc assembly 104 from the valve seat 110. The pressure sensor 138 can then relay a sensed pressure at the valve inlet 108 to the controller 122 to indicate whether a relief event has occurred to verify whether the valve 100 will open during system operation when a set pressure is reached.

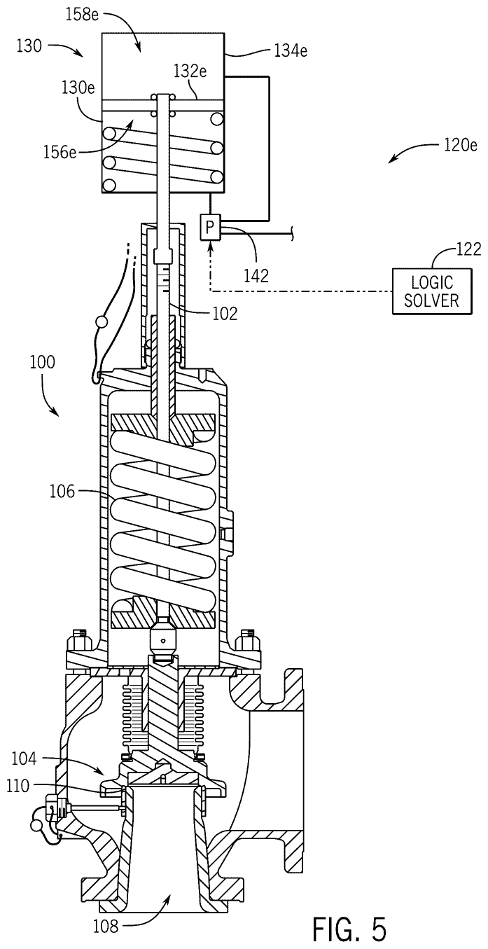

FIG. 5 illustrates another example embodiment of a control system 120e. In the illustrated embodiment, the control system 120e includes a controller 122 (e.g., a logic solver) in communication with a positioner 142 and an actuator 130 configured as a piston-cylinder assembly 130e that is attached to the spindle 102 of the relief valve 100. In the illustrated embodiment, the actuator 130 is a two-way actuator and is pressure-operated. Correspondingly, the positioner 142 can generally control the piston 132e to move in two directions to at least partially open the valve 100 and to close the valve 100. To open the valve 100 at least partially, the positioner 142 can pressurize a first side 156e of the piston 132e within the piston-cylinder 130e to thereby lift the disc assembly 104 via the spindle 102. To close the valve 100 and provide supplemental loading, the positioner 142 can pressurize a second side 158e of the piston 132e to move the disc assembly 104 toward the valve seat 110.

In use, a partial stroke test may be conducted by signaling to the positioner 142 to actuate the piston-cylinder assembly 130e to lift the disc assembly 104 from the valve seat 110. The positioner 142 can then relay a sensed position of the piston 132e within the piston-cylinder assembly 130e, which corresponds to a lift height of the disc assembly 104 to thereby verify that the valve 100 will open during a relief event. Further, the force applied to lift the disc assembly 104 from the valve seat 110 can be derived from the pressure provided by the positioner 142 and the characteristics of the piston-cylinder assembly 130e, and the pressure required to open the valve 100 (i.e., the set pressure) can be determined accordingly. The control system 120e illustrated in FIG. 5 can also conduct operational diagnostics, as described above.

As also generally noted above, in the embodiments described above with reference to FIGS. 1-5, a limit switch or position sensor can additionally or alternatively be implemented in a control system 120a-e for the spring-operated pressure relief valve 100. For example, a limit switch or position sensor can be configured to be in communication with a controller and disposed to measure displacement of a spindle of a relief valve or other associated structure. During a test for the relief valve, such as a partial stroke test, for example, the actuator can move the disc assembly away from the valve seat to open the valve until a designated lift height is reached, as indicated by the limit switch or position sensor. Once the designated lift height has been reached, the actuator can then cease control of the disc assembly, as appropriate. In a similar way, other position sensors can be implemented within any variety of control systems disclosed herein.

In general, pressure relief valve maintenance schedules may follow a risk-based evaluation based on prior repair history, service criticality, and general service conditions. Adding regularly scheduled autonomous testing with leakage and event detection to a relief valve can generally provide a more accurate perspective on pressure relief valve performance and reliability.

While autonomous control and operational characteristics of pressure relief valves have generally been described above with reference to spring-operated pressure relief valves, similar control systems and mechanisms may also be applied to pilot-operated pressure relief valves. In general, pilot-operated pressure relief valves can provide significant weight and space savings when compared to other pressure relief valves, such as conventional direct spring valves and automated/actuated valve packages. Some pilot-operated pressure relief valves, including modulating pilot valves, respond when an inlet pressure equals a set pressure by opening only enough to flow sufficient product to relieve an overpressure event, which can generally minimize waste of product and emissions.

When a system that employs a pilot-operated pressure relief valve exceeds a set pressure (or set point), the pressure relief valve opens, which can release the contents of the system (e.g., liquid, gas, or both). The release of the contents can create a turbulence, which thereby generates mechanical vibrations. In general, the mechanical vibrations can be detected and reported by an acoustic monitor. Likewise, any small leakage can generate turbulence inside a discharge pipe of the pilot-operated pressure relief valve and cause mechanical vibration that is detectable by the acoustic transmitter.

Further, pilot-operated pressure relief valves generally use a system pressure as a holding pressure to keep the main valve closed. The system pressure and the holding pressure are generally equal to close the valve. By interpolating intrinsic characteristics of the valve with a differential pressure measurement between the system pressure and the holding pressure, it is possible to gauge the flow passing through the main valve of the pilot-operated pressure relief valve when the valve opens, as also discussed in U.S. patent application Ser. No. 16/588,850. Thus, in some cases, differential pressure measurements can be correlated to valve lift and other associated parameters for a particular relief event of a particular pilot-operated pressure relief valve.

Various embodiments of the invention can allow partial stroke tests to also be conducted in pilot-operated pressure relief valves, using similar principles as discussed above relative to spring-operated pressure relief valves. In some embodiments, partial stroke testing of a pilot-operated pressure relief valve can be accomplished by positioning a control valve between a pilot valve of a pilot-operated pressure relief valve, and a dome. The partial stroke test can be initiated by sending a control signal to the control valve, which can cause the control valve to relieve pressure from the dome of the pressure relief valve. As long as the pressure relief valve is functioning as expected, the pressure imbalance between the dome and an inlet of the pressure relief valve results in a piston of the pressure relief valve lifting from the valve seat, thus opening the pressure relief valve and enabling flow from the inlet to the outlet of the pressure relief valve.

A successful operation of the pilot-operated pressure relief valve can be verified via one or more evaluation instruments, such as a dome-inlet differential pressure transmitter (for measuring the differential pressure between the dome and inlet of the pressure relief valve), an inlet pressure transmitter (for measuring the pressure at the inlet of the pressure relief valve), an acoustic transmitter (for measuring acoustic activity associated with flow through the pressure relief valve), a direct position sensor (for measuring the lift of the piston), or any variety of combinations of these instruments.

In one embodiment, a partial stroke test may be automatically concluded when the measurements indicate a predetermined amount of lift of the pressure relief valve (e.g., 10% lift). In one embodiment, one or more evaluation instruments can be connected to the control system, such that the partial stroke test may be initiated and the results can be evaluated from a common system. Further, although some embodiments include a control valve positioned between the pilot valve and the dome, a partial stroke test can also be performed in some cases via direct actuation of a pilot valve (e.g., via a pneumatic, electric, or hydraulic actuator coupled to a piston of the pilot valve). In such embodiment, for example, a control signal to the control test valve to initiate the partial stroke test may be replaced by a control signal to an actuator for the pilot valve.

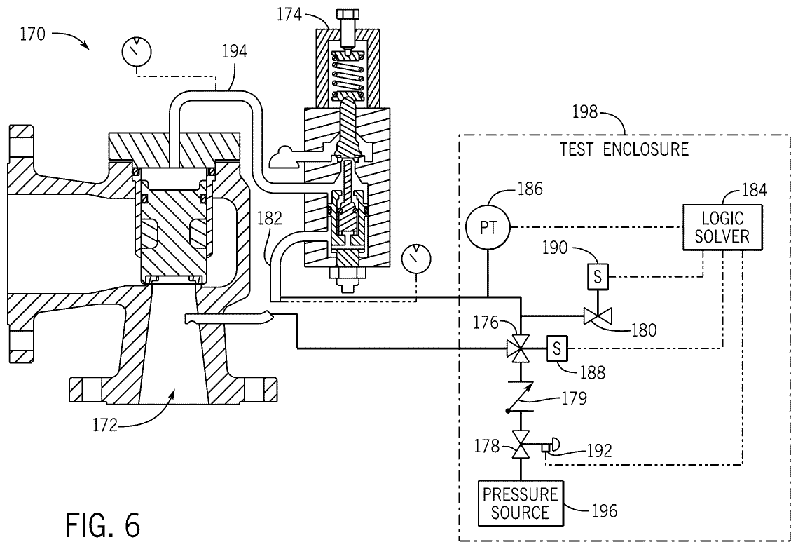

Set pressure validation of a pressure relief valve (PRV) is accomplished by permitting a control fluid that is contained within a pressure source (e.g., nitrogen in a storage tank) to act on the PRV's associated pilot valve during a set pressure validation test. In the illustrated embodiment of FIG. 6, pressure at an inlet 172 of a PRV 170 is routed to a pilot 174 through a test enable valve 176. During a set pressure validation test, the control fluid is routed to the pilot valve 174 through a pressure control valve 178, a check valve 179 that only permits flow in the direction from the pressure source 196 to the test enable valve 176. Although illustrated as a solenoid-operated valve, the test enable valve may alternatively be implemented as a manual three-way check valve that passes the higher of the PRV inlet pressure or the pressure control valve outlet pressure to the pilot inlet 182. A dump valve 180 permits fluid to be exhausted from the pilot valve inlet 182.

A logic solver 184 can receive and provide signals to and from multiple instruments, including an analog input from a pressure transmitter 186 that indicates the pressure at the inlet 182 to the pilot valve 174, a discrete output to a solenoid operator 188 for the test enable valve 176, a discrete output to a solenoid operator 190 for the dump valve 180, and an analog output to a positioner 192 that sets the position of the pressure control valve 178. As will be understood by those of ordinary skill in the art, the inputs and outputs to and from the logic solver 184 may be standard electrical control signals or communications via a communications bus such as fieldbus. The test enable valve 176 is configured as a three-way valve that functions to pass either the fluid from the PRV inlet 172 or the control fluid to the pilot inlet 182. In normal operation, the discrete output signal from the logic solver 184 to the test enable solenoid-operated valve 176 is de-energized. In this de-energized state, the test enable valve 176 permits flow from the PRV inlet 172 to the test enable valve outlet, which is coupled to the inlet 182 of the pilot valve 174, and prevents flow from the pressure source 196 through the test enable valve 176. In this normal configuration, the PRV 170 works in the typical manner with the PRV inlet pressure routed to the pilot valve 174 such that when the PRV inlet pressure exceeds the pilot valve's setpoint, the pilot valve 174 opens to vent the dome 194, thus opening the PRV 170 and relieving the excess pressure at the PRV inlet 172.

When a test is initiated, the logic solver 184 energizes the solenoid-operated test enable valve 176. In this energized state, the test enable valve 176 prevents flow from the PRV inlet 172 to the test enable valve 176 outlet and permits flow from a pressure source 196 through the test enable valve to the pilot valve 176. In this test configuration, the pressure source 196 is fluidly coupled (via the pressure control valve 178) to the pilot valve 174. After energizing the test enable solenoid-operated valve 176, the logic solver 184 initiates a pressure ramp routine in which a PID control algorithm operating in the logic solver 184 utilizes an input from the pressure transmitter 186 and an output to the pressure control valve 178 to slowly increase the pressure of the control fluid from the pressure source 196 that is routed to the pilot valve 174 over a pre-configured pressure range. When the pressure at the pilot valve 174 exceeds the pilot valve's set point, the pilot valve 174 opens to vent the dome 194 and cause the PRV 170 to open in the same manner as in normal operation. A PRV opening can be verified via one or more (i.e., a combination) of evaluation instruments, such as a dome-inlet differential pressure transmitter (for measuring the differential pressure between a dome and an inlet of a PRV), an inlet pressure transmitter (for measuring the pressure at an inlet of a PRV), an acoustic transmitter (for measuring acoustic activity associated with flow through a PRV), or a direct position sensor (for measuring the lift of a PRV's piston). Any one or more of these evaluation instruments (and others) may be configured to communicate with the logic solver.

The set pressure validation test may be concluded when either a maximum pressure set point is reached without verification that the PRV 170 opened or when PRV opening is verified. The set pressure of the PRV 170 is equal to the pressure that is measured at the pilot inlet 182 (and reported to the logic solver 184 by the pressure transmitter 186) at the time the PRV 170 opens. Upon conclusion of the test, the logic solver 184 instructs the pressure control valve 178 to go to the closed position, opens the solenoid-operated dump valve 180 until the test pressure is relieved (e.g., until the input from the pressure transmitter 186 reaches a predetermined value such as a predetermined percentage of the pressure value immediately before the test is initiated), and then de-energizes the solenoid-operated test enable valve 176 to return it to the normal configuration.

In the illustrated embodiment, the logic solver 184, test-related instrumentation, and pressure source 196 are packaged within a test enclosure 198. The test enclosure 198 may be configured as a package with the pressure relief valve or may be connected to existing pilot-operated pressure relief valves with an easy re-tubing operation. The logic solver 184 may be configured to communicate with a plant control system such as a distributed control system, a safety instrumented system, a plant maintenance system, etc., such that the connected system can be used to provide test parameters, initiate a test, and receive test results.

As also noted above, in some embodiments, a control system may interact with an actuator that is directly coupled to a pilot valve of a pilot-operated pressure relief valve to perform a set pressure validation test that does not require a control fluid. In such embodiments, when a set pressure validation test is initiated, a control system can issue a control signal to cause the pilot-coupled actuator to gradually increase an opening force that operates on the pilot. When the opening force supplied by the actuator (which can be electrical, hydraulic, or pneumatic) exceeds the pilot's set pressure, the pilot valve will unload the dome of the associated pressure relief valve, causing the pressure relief valve to open.

The opening of a pressure relief valve can be verified via one or more evaluation instruments, including a dome-inlet differential pressure transmitter (for measuring the differential pressure between the dome and inlet of the pressure relief valve), an inlet pressure transmitter (for measuring the pressure at the inlet of the pressure relief valve), an acoustic transmitter (for measuring acoustic activity associated with flow through the pressure relief valve), a direct position sensor (for measuring the lift of a piston of the pressure relief valve), and/or a combination of these instruments. The opening force required to cause the PRV to open is related to the PRV set pressure and can therefore be used to validate the set pressure.

In some embodiments, one or more evaluation instruments can be connected to the control system such that the set pressure validation test can be concluded (e.g., by adjusting the control signal to the pilot-coupled actuator) when the one or more evaluation instruments indicate that the pressure relief valve has opened. In some embodiments, the output to the pilot-coupled actuator or the force applied by the actuator at the time the pressure relief valve opens can be measured and recorded to provide an indication of the set pressure.

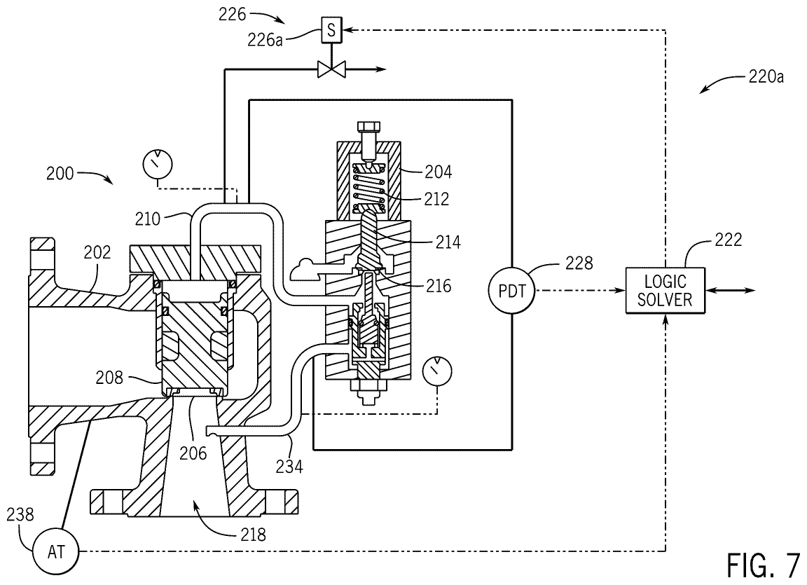

The descriptions of FIGS. 7-10 below provide various example embodiments of a control system 220a-d for a pilot-operated pressure relief valve 200 according to one or more of the general principles discussed above. Each pilot-operated relief valve 200 of the control system embodiments 220a-d described below generally includes a main valve 202 and a pilot valve 204. The main valve 202 includes a main valve seat 206, a main piston 208 configured to seal against the main valve seat 206, and a dome 210. The pilot valve 204 includes a pilot spring 212 that can bias a valve member, configured as a pilot piston 214, toward a pilot seat 216 to control flow through the pilot valve 204. The pilot valve 204 is in communication with an inlet 218 of the main valve 202 and the dome 210, to control a pressure within the dome 210.

Additionally, each embodiment described below provides remote actuation of the control system 220a-d via a controller 222. Further, each embodiment described below allows certain tests and operation characteristics to be determined such as partial stroke test and set pressure, including according to the various principles discussed generally above. In general, like reference numbers for the same or similar components, where applicable, will be used across the various example embodiments below in varying configurations.

FIG. 7 illustrates one example of a control system 220a that includes a pressure sensor 228, a controller 222 (e.g., a logic solver), and a vent valve 226 (e.g., a solenoid valve 226a). The pressure sensor 228 is arranged to measure a pressure difference between an inlet 234 to the pilot valve 204 and the dome 210. For example, in the illustrated embodiment, the pressure sensor 228 is configured as a single differential pressure transmitter. The vent valve 226 is in communication with the dome 210 and atmosphere or another pressure sink. In the illustrated embodiment, the vent valve 226 is configured as the solenoid valve 226a, however, other valves are possible.

In use, the controller 222 can control the vent valve 226 to at least partially vent the dome 210, to cause the main piston 208 to reduce pressure in the dome 210 and thereby at least partially open the main valve 202 for flow across the main valve seat 206. In particular, the solenoid valve 226a is configured to artificially vent the dome 210 before the set pressure is sensed by the pilot valve 204 to provide a partial stroke test, and thereby verify that the valve 200 will function as expected during a relief event. During the venting event provided by the solenoid valve 226a, the vent valve must sufficiently vent pressure out of the dome 210 at a faster rate than the pilot valve 204 can provide a closing force on the main valve 202, as can be achieved via proper sizing of the vent valve relative to the larger system. The partial stroke test is complete when a desired lift of the main valve 202 from the valve seat 206 is determined. The valve lift can be sensed by the pressure sensor 228 (e.g., the pressure differential between the inlet and the dome is identified as suitably reduced) or another sensor that is configured to measure the main valve lift (e.g., a limit switch or position transmitter) or from which a main valve lift can be implied (e.g., an acoustic transmitter).

In some cases, the controller 222 can also be configured to conduct certain operational diagnostics of the pilot-operated pressure relief valve 200. For example, the controller 222 (e.g., a logic solver) can record the length of time required to lift the piston 208 a predetermined amount or percentage which can correspond to a specified valve lift of the main valve 202 (e.g., with the valve lift determined as is described in U.S. patent application Ser. No. 16/588,850, which is incorporated herein by reference). As described above, with reference to the spring-operated pressure relief valve 200, a first time required to open the main valve 202 to a specified lift can be compared with a second time required to open the main valve 202 to the specified lift to identify an operational state of the pilot-operated pressure relief valve 200, including to evaluate wear and tear over time or other indicators of overall health of the valve.

As further illustrated in FIG. 7, in some embodiments, a sensor 238 can be disposed downstream of the main valve seat 206. For example, such sensor 238 can include an acoustic transmitter, as described above. In use, when the main valve 202 is at least partially opened by the control of the vent valve 226 (i.e., the solenoid 226a), the controller 222 is configured to identify a set pressure of the pilot-operated pressure relief valve 200 based on a signal from the sensor 238 downstream of the main valve seat 206. For example, an acoustic transmitter may signal a relief event based on vibrations felt downstream of the main valve seat 206, and a corresponding pressure measurement (e.g., by the differential pressure transmitter) can be used to identify the set pressure.

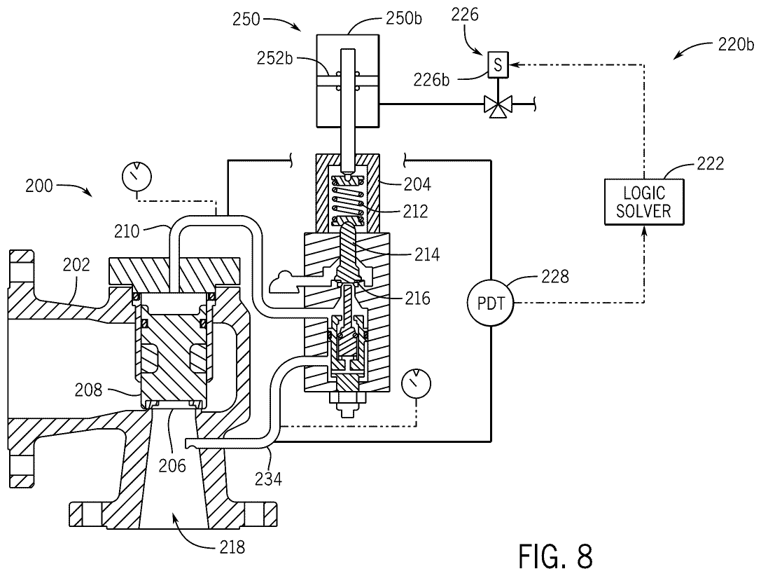

FIGS. 8-10 illustrate other examples of control systems 220b-d for a pilot-operated pressure relief valve 200. Each control system 220b-d described includes a pressure sensor 228 that can measure a pressure difference between an inlet 234 to the pilot valve 204 and the dome 210, a controller 222, and an actuator 250 connected to a piston 214 of the pilot valve 204. In general, the controller 222 can control the actuator 250 to control the pilot piston 214 to at least partially open the pilot valve 204 and thereby vent the dome 210. The pressure sensor 228 can be configured as a differential pressure transmitter, however, other pressure sensors are possible, and can be used to indicate pressure in general or to calculate valve lift (e.g., as described above). The actuator 250 can be an electric, hydraulic or pneumatic actuator of any variety of known types. Generally, consistent with the principles generally presented above, the control system 220b-d can thus be configured to determine one or more operational characteristics of the pilot-operated pressure relief valve 200, based on a response of the valve 200 to the controlled movement of the pilot piston 214, including confirmation of a partial stroke test, identification of set pressure, and execution of various diagnostics, including as described above.

With reference to FIG. 8, a control system 220b can include a controller 222 in communication with a solenoid valve 226b, however, other control valves are possible, and an actuator 250 that is configured as a piston-cylinder assembly 250b connected to a piston 214 of the pilot valve 204. In some embodiments, the actuator 250 may be connected to one or more of an upper spring plate of the pilot valve 204, a lower spring plate of the pilot valve 204, or otherwise extending through the pilot spring 212 to actuate the pilot valve 204.

In the illustrated embodiment, the actuator 250 (i.e., the piston-cylinder assembly 250b) is a one-way actuator and is pressure-operated (e.g., via hydraulic or pneumatic pressure). Correspondingly, in general, the solenoid 226b can control a piston 252b of the piston-cylinder assembly 250b in a single direction to at least partially open the main valve 208 of the pilot-operated pressure relief valve 200. The controller 222 (via the solenoid 226b) can controllably direct a pressurized fluid to the actuator 250 to move the pilot piston 214. For example, to pressurize the piston-cylinder assembly 250b, the solenoid 226b can be energized (e.g., via a signal from a logic solver), and the solenoid 226b can be de-energized to vent the piston-cylinder assembly 250b.

In use, a partial stroke test may be conducted by signaling to the controller 222 to actuate the piston-cylinder assembly 250b to open the pilot valve 204. As described above with reference to FIG. 7, the pressure sensor 228 can then relay a sensed differential pressure between the inlet 234 to the pilot valve 204 and the dome 210 to indicate whether a relief event has or has not occurred, to verify whether the main valve 202 will open during system operation when a set pressure is reached. Additionally, similarly as described above, the control system 220b illustrated in FIG. 8 can be configured to conduct operational diagnostics of the pilot-operated pressure relief valve 200.

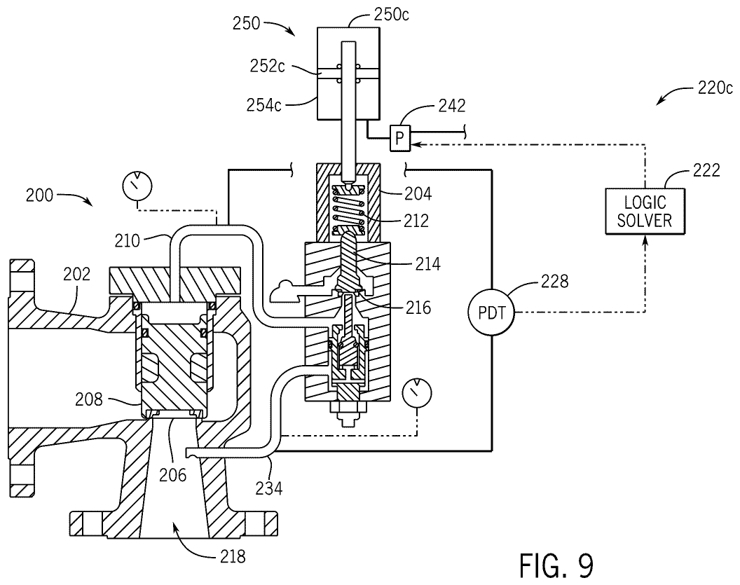

FIG. 9 illustrates another example embodiment of a control system 220c. In the illustrated embodiment, the control system includes 220c a controller 222 in communication with a positioner 242 and an actuator 250 configured as a piston-cylinder assembly 250c connected to a piston 214 of the pilot valve 204. In the illustrated embodiment, the actuator 250 is a one-way actuator and is pressure-operated. Correspondingly, the positioner 242 can generally control a piston 252c of the piston-cylinder assembly 250c in a single direction to at least partially open the main valve 202 of the pilot-operated pressure relief valve 200, controllably moving the piston 252c within the piston-cylinder assembly 250c by increasing or decreasing pressure within the cylinder 254c.

In use, a partial stroke test may be conducted by signaling to the positioner 242 to actuate the pilot piston 214 by moving the actuator 250 a known distance. As described above, a pressure sensor 228 can then relay a sensed differential pressure between the inlet 234 to the pilot valve 204 and the dome 210 to indicate whether a relief event has occurred and determine the set pressure (e.g., as generally described above). Additionally, similarly as described above, the control system 220c illustrated in FIG. 9 can be configured to conduct operational diagnostics of the pilot-operated pressure relief valve 200.

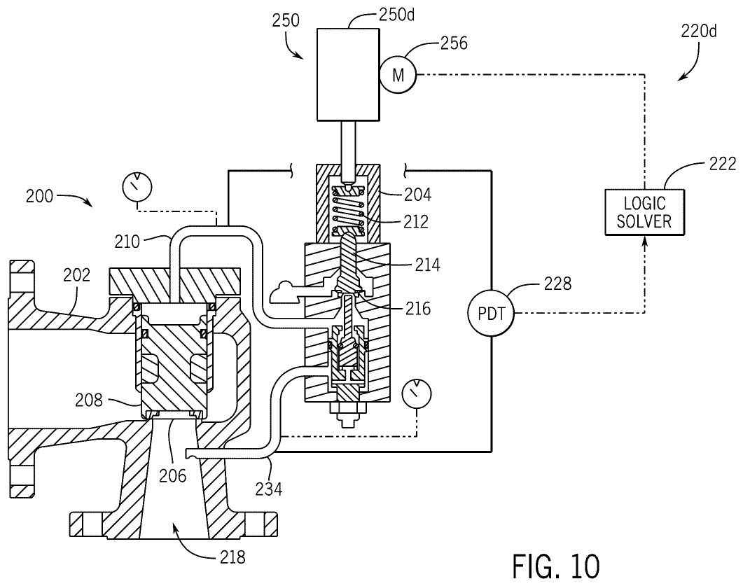

FIG. 10 illustrates another example embodiment of a control system 220d. As shown, the actuator 250 is configured as an electric actuator 250d. In the illustrated embodiment, the control system 220d includes a controller 222 configured to actuate an electric motor 256 of the electric actuator 250d, which is connected to the pilot piston 214 of the pilot-operated pressure relief valve. The motor 256 can control the pilot piston 214 to open and close the main valve 202 of the pilot-operated pressure relief valve 200.

In use, a partial stroke test may be conducted by signaling to the motor 256 to actuate the pilot piston 214 and moving the actuator 250 a known distance. As described above, a pressure sensor 228 can then relay a sensed differential pressure between the inlet 234 to the pilot valve 204 and the dome 210 to indicate whether a relief event has occurred and determine the set pressure (e.g., as generally described above). Additionally, as similarly described above, the control system 220d illustrated in FIG. 10 can be configured to conduct operational diagnostics of the pilot-operated pressure relief valve 200.

Thus, embodiments of the disclosed invention can provide an improvement over conventional arrangements for setting a set pressure of a spring-operated relief valve, detecting crack or set pressure of the valve, or otherwise monitoring the valve during operation. The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. A control system for a pressure relief valve with a valve member configured to seal against a valve seat, the control system comprising:
a controller; and
an actuator connected to the valve member;
the controller configured to:
control the actuator to move the valve member, to at least partially open the valve; and
determine one or more operational characteristics of the pressure relief valve based on a response of the valve to the controlled movement of the valve member, including:
determining a force applied by the actuator or a force input at the actuator corresponding to opening the valve; and
determining a set pressure of the valve based on the force applied by the actuator or the force input at the actuator.

2. The control system of claim 1, wherein the pressure relief valve is a spring-operated pressure relief valve.

3. The control system of claim 2, wherein the controller is configured to determine the set pressure by correlating the force applied by the actuator to a corresponding fluid pressure required to overcome a spring force of a spring of the spring-operated pressure relief valve.

4. The control system of claim 1, wherein the pressure relief valve is a pilot-operated pressure relief valve.

5. The control system of claim 1, wherein the actuator is a pneumatic actuator, and the force input at the actuator is determined based on a pneumatic pressure supplied to the pneumatic actuator.

6. The control system of claim 1, wherein the actuator is a hydraulic actuator, and the force input at the actuator is determined based on a hydraulic pressure supplied to the hydraulic actuator.

7. The control system of claim 1, wherein the actuator is a motor, and the force applied by the actuator is determined based on a current through the motor.

8. The control system of claim 1, wherein the controller is further configured to:
gradually increase the force applied by the actuator until the valve opens, and determine the set pressure based on the force applied at the time the valve opens.

9. The control system of claim 1, further comprising:
a pressure sensor configured to measure a pressure at an inlet of the pressure relief valve; and
wherein the controller is configured to:
correlate the force applied by the actuator to the pressure measured by the pressure sensor to determine the set pressure.

10. A method of operating a control system of a pilot-operated pressure relief valve, the method comprising:
conducting operational diagnostics of the pilot-operated pressure relief valve by:
with a controller, controlling an actuator to open a main valve of the pilot-operated pressure relief valve;
determining a force applied by the actuator or a force input at the actuator corresponding to opening the main valve; and
determining a set pressure of the pilot-operated pressure relief valve based on the force applied by the actuator or the force input at the actuator.

11. The method of claim 10, wherein an open state of the valve is determined based on one or more of:
a sensor located downstream of a main valve seat; or
a pressure sensor arranged to measure a pressure difference between an inlet to a pilot valve of the pilot-operated pressure relief valve and a dome of the main valve.

12. The method of claim 10, wherein determining the set pressure includes:
correlating the force applied by the actuator to a corresponding fluid pressure required to overcome a pilot spring force of a pilot valve of the pilot-operated pressure relief valve.

13. The method of claim 10, wherein the actuator is a pneumatic actuator, and the force input at the actuator is determined based on a pneumatic pressure supplied to the pneumatic actuator.

14. The method of claim 10, wherein the actuator is a hydraulic actuator, and the force input at the actuator is determined based on a hydraulic pressure supplied to the hydraulic actuator.

15. The method of claim 10, wherein the actuator is a motor, and the force applied by the actuator is determined based on a current through the motor.

16. The method of claim 10, further comprising:
gradually increasing the force applied by the actuator until the main valve opens; and
determining the set pressure based on the force applied at the time the main valve opens.

17. The method of claim 10, further comprising:
measuring a pressure at an inlet of the pilot-operated pressure relief valve, and correlating the force applied by the actuator with the measured pressure to determine the set pressure.

18. A control system for a pilot-operated pressure relief valve having a main valve with a main piston configured to seal against a main valve seat and a pilot valve with a pilot piston configured to control pressure within a dome of the main valve, the control system comprising:
a controller;
an actuator connected to the pilot piston of the pilot valve; and
a pressure sensor configured to measure a pressure difference between an inlet to the pilot valve and the dome;
the controller configured to:
control the actuator to move the pilot piston to at least partially open the pilot valve and vent the dome to cause the main piston to at least partially open the main valve;
determine a force applied by the actuator or a force input at the actuator corresponding to opening the pilot valve; and
determine a set pressure of the pilot-operated pressure relief valve based on the force applied by the actuator or the force input at the actuator.

19. The control system of claim 18, wherein the controller is further configured to:
determine the set pressure by correlating the force applied by the actuator to a corresponding fluid pressure needed to overcome a pilot spring force of the pilot valve.

20. The control system of claim 18, wherein the controller is further configured to:
gradually increase the force applied by the actuator until the main valve opens; and
determine the set pressure based on the force applied at the time the main valve opens.
